(19) United States
(12) Patent Application Publication
(10) Pub. No.: US 2024/0236866 A9
(43) Pub. Date: Jul. 11, 2024

(54) DOWNLINK POWER CONTROL RECOMMENDATION FOR CROSS LINK INTERFERENCE REDUCTION IN FULL DUPLEX NETWORKS

(71) Applicant: QUALCOMM Incorporated, San Diego, CA (US)

(72) Inventors: Ahmed Attia Abotabl, San Diego, CA (US); Muhammad Sayed Khairy Abdelghaffar, San Jose, CA (US); Abdelrahman Mohamed Ahmed Mohamed Ibrahim, San Diego, CA (US)

(21) Appl. No.: 17/970,551

(22) Filed: Oct. 20, 2022

(51) Int. Cl. H04W 52/14; H04W 52/24

(52) U.S. Cl. CPC H04W 52/143; H04W 52/241

(57) ABSTRACT

Methods, systems, and devices for wireless communications are described. The techniques described herein relate to a user equipment (UE) that monitors performance of downlink transmission from a network entity to the UE, and provides a dynamic downlink transmission power recommendation. The UE may receive control signaling that indicates configuration information for dynamic reporting of the recommended downlink transmission power level for the network entity to apply for subsequent downlink transmission. The UE may receive, from the network entity, a downlink transmission in accordance with the configuration information. The UE may transmit, to the network entity, a dynamic message including an indication of the recommended downlink transmission power level for the network entity based on receiving the downlink transmission in accordance with the configuration information.

### FIELD OF TECHNOLOGY

The present disclosure relates to wireless communications, including downlink power control recommendation for cross link interference reduction in full duplex networks.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support downlink power control recommendation for cross link interference (CLI) reduction in full duplex networks. In some full-duplex communications, a user equipment (UE) may experience CLI, which may degrade a signal quality of a downlink message received at the UE. Reducing the power of a downlink transmissions may decrease the CLI caused by the downlink transmission to other UEs, but may also reduce the performance of the downlink transmission (e.g., likelihood of reception by the target UE). The described techniques provide for a dynamic downlink transmission power recommendation to the network entity based on a monitored downlink transmission. The network entity may dynamically adjust downlink transmission power to manage the tradeoff between CLI at other UEs and the downlink transmission accuracy at the receiving UE. In some examples, the network entity may configure the UE to periodically report a downlink transmission power recommendation, for example in reporting resources linked to CLI reporting resources. In some examples, the network entity may dynamically request a downlink transmission power recommendation (e.g., via downlink control information). The UE may determine a recommended downlink transmission power level, for example based on a relationship between the channel state information (CSI) and a received downlink transmission, a relationship between the CLI and a received downlink transmission, a decoding performance of the UE for a received downlink transmission, a quantity of iterations used to decode a downlink transmission, or a measurement of downlink transmission performance.

A method for wireless communications at a UE is described. The method may include receiving, from a network entity, control signaling indicating configuration information for dynamic reporting of a recommended downlink transmission power level for the network entity to apply for subsequent downlink transmission, receiving, from the network entity, a downlink transmission in accordance with the configuration information, and transmitting, to the network entity, a dynamic message including an indication of the recommended downlink transmission power level for the network entity to apply for subsequent downlink transmission based on receiving the downlink transmission in accordance with the configuration information.

An apparatus for wireless communications at a UE is described. The apparatus may include a processor, memory coupled with the processor, and instructions stored in the memory. The instructions may be executable by the processor to cause the apparatus to receive, from a network entity, control signaling indicating configuration information for dynamic reporting of a recommended downlink transmission power level for the network entity to apply for subsequent downlink transmission, receive, from the network entity, a downlink transmission in accordance with the configuration information, and transmit, to the network entity, a dynamic message including an indication of the recommended downlink transmission power level for the network entity to apply for subsequent downlink transmission based on receiving the downlink transmission in accordance with the configuration information.

Another apparatus for wireless communications at a UE is described. The apparatus may include means for receiving, from a network entity, control signaling indicating configuration information for dynamic reporting of a recommended downlink transmission power level for the network entity to apply for subsequent downlink transmission, means for receiving, from the network entity, a downlink transmission in accordance with the configuration information, and means for transmitting, to the network entity, a dynamic message including an indication of the recommended downlink transmission power level for the network entity to apply for subsequent downlink transmission based on receiving the downlink transmission in accordance with the configuration information.

A non-transitory computer-readable medium storing code for wireless communications at a UE is described. The code may include instructions executable by a processor to receive, from a network entity, control signaling indicating configuration information for dynamic reporting of a recommended downlink transmission power level for the network entity to apply for subsequent downlink transmission, receive, from the network entity, a downlink transmission in accordance with the configuration information, and transmit, to the network entity, a dynamic message including an indication of the recommended downlink transmission power level for the network entity to apply for subsequent downlink transmission based on receiving the downlink transmission in accordance with the configuration information.

In some examples of the method, apparatuses, and non-transitory computer-readable medium described herein, receiving the control signaling may include operations, features, means, or instructions for receiving, with the configuration information, an indication of a set of periodic reporting resources for the dynamic reporting, and where transmitting the dynamic message includes transmitting the dynamic message via a periodic reporting resource of the set of periodic reporting resources.

Some examples of the method, apparatuses, and non-transitory computer-readable medium described herein may further include operations, features, means, or instructions for receiving, from the network entity, second control signaling requesting that the UE report the recommended downlink transmission power level in accordance with the configuration information, where transmitting the dynamic message may be responsive to the second control signaling.

In some examples of the method, apparatuses, and non-transitory computer-readable medium described herein, receiving the control signaling may include operations, features, means, or instructions for receiving, with the configuration information, a set of power offsets and a set of reference powers, and where the indication of the recommended downlink transmission power level includes an indication of a selected power offset of the set of power offsets.

In some examples of the method, apparatuses, and non-transitory computer-readable medium described herein, the indication of the recommended downlink transmission power level further includes an indication of a reference power of the set of reference powers.

In some examples of the method, apparatuses, and non-transitory computer-readable medium described herein, receiving the control signaling may include operations, features, means, or instructions for receiving, with the configuration information, an indication of a set of resources associated with the set of reference powers, and where transmitting the dynamic message includes transmitting the dynamic message via a resource of the set of resources.

In some examples of the method, apparatuses, and non-transitory computer-readable medium described herein, the set of reference powers may be a CSI reference signal transmission power.

In some examples of the method, apparatuses, and non-transitory computer-readable medium described herein, receiving the control signaling may include operations, features, means, or instructions for receiving, with the configuration information, a set of absolute power levels, where transmitting the dynamic message includes transmitting an indication of a selected absolute power level of the set of absolute power levels.

Some examples of the method, apparatuses, and non-transitory computer-readable medium described herein may further include operations, features, means, or instructions for generating measurement information based on the downlink transmission, where the recommended downlink transmission power level may be based on the measurement information.

In some examples of the method, apparatuses, and non-transitory computer-readable medium described herein, generating the measurement information may include operations, features, means, or instructions for generating one of a log likelihood ratio or a block error ratio based on the downlink transmission.

In some examples of the method, apparatuses, and non-transitory computer-readable medium described herein, generating the measurement information may include operations, features, means, or instructions for measuring a decoding performance of downlink transmission.

Some examples of the method, apparatuses, and non-transitory computer-readable medium described herein may further include operations, features, means, or instructions for determining a change in a CLI measurement at the UE or in a CSI measurement at the UE based on the downlink transmission, where the recommended downlink transmission power level may be based on the change.

A method for wireless communications at a network entity is described. The method may include transmitting, to a UE, control signaling indicating configuration information for dynamic reporting of a recommended downlink transmission power level for the network entity to apply for subsequent downlink transmission, transmitting, to the UE, a downlink transmission in accordance with the configuration information, and receiving, from the UE, a dynamic message including an indication of the recommended downlink transmission power level for the network entity to apply for subsequent downlink transmission based on transmitting the downlink transmission in accordance with the configuration information.

An apparatus for wireless communications at a network entity is described. The apparatus may include a processor, memory coupled with the processor, and instructions stored in the memory. The instructions may be executable by the processor to cause the apparatus to transmit, to a UE, control signaling indicating configuration information for dynamic reporting of a recommended downlink transmission power level for the network entity to apply for subsequent downlink transmission, transmit, to the UE, a downlink transmission in accordance with the configuration information, and receive, from the UE, a dynamic message including an indication of the recommended downlink transmission power level for the network entity to apply for subsequent downlink transmission based on transmitting the downlink transmission in accordance with the configuration information.

Another apparatus for wireless communications at a network entity is described. The apparatus may include means for transmitting, to a UE, control signaling indicating configuration information for dynamic reporting of a recommended downlink transmission power level for the network entity to apply for subsequent downlink transmission, means for transmitting, to the UE, a downlink transmission in accordance with the configuration information, and means for receiving, from the UE, a dynamic message including an indication of the recommended downlink transmission power level for the network entity to apply for subsequent downlink transmission based on transmitting the downlink transmission in accordance with the configuration information.

A non-transitory computer-readable medium storing code for wireless communications at a network entity is described. The code may include instructions executable by a processor to transmit, to a UE, control signaling indicating configuration information for dynamic reporting of a recommended downlink transmission power level for the network entity to apply for subsequent downlink transmission, transmit, to the UE, a downlink transmission in accordance with the configuration information, and receive, from the UE, a dynamic message including an indication of the recommended downlink transmission power level for the network entity to apply for subsequent downlink transmission based on transmitting the downlink transmission in accordance with the configuration information.

Some examples of the method, apparatuses, and non-transitory computer-readable medium described herein may further include operations, features, means, or instructions for transmitting, to the UE, a second downlink transmission based on the recommended downlink transmission power level and one or more second recommended downlink transmission powers received from one or more other UEs.

In some examples of the method, apparatuses, and non-transitory computer-readable medium described herein, transmitting the control signaling may include operations, features, means, or instructions for transmitting, with the configuration information, an indication of a set of periodic reporting resources for the dynamic reporting, and where receiving the dynamic message includes receiving the dynamic message via a periodic reporting resource of the set of periodic reporting resources.

Some examples of the method, apparatuses, and non-transitory computer-readable medium described herein may further include operations, features, means, or instructions for transmitting, to the UE, second control signaling requesting that the UE report the recommended downlink transmission power level in accordance with the configuration information, where receiving the dynamic message may be based on the second control signaling.

In some examples of the method, apparatuses, and non-transitory computer-readable medium described herein, transmitting the control signaling may include operations, features, means, or instructions for transmitting, with the configuration information, a set of power offsets and a set of reference powers, and where the indication of the recommended downlink transmission power level includes an indication of a selected power offset of the set of power offsets.

In some examples of the method, apparatuses, and non-transitory computer-readable medium described herein, the indication of the recommended downlink transmission power level further includes an indication of a reference power of the set of reference powers.

In some examples of the method, apparatuses, and non-transitory computer-readable medium described herein, transmitting the control signaling may include operations, features, means, or instructions for transmitting, with the configuration information, an indication of a set of resources associated with the set of reference powers, and where receiving the dynamic message includes receiving the dynamic message via a resource of the set of resources.

In some examples of the method, apparatuses, and non-transitory computer-readable medium described herein, the set of reference powers may be a CSI reference signal transmission power.

In some examples of the method, apparatuses, and non-transitory computer-readable medium described herein, transmitting the control signaling may include operations, features, means, or instructions for transmitting, with the configuration information, a set of absolute power levels, where receiving the dynamic message includes receiving an indication of a selected absolute power level of the set of absolute power levels.

### BRIEF DESCRIPTION OF THE DRAWINGS

FIG. 1 illustrates an example of a wireless communications system that supports downlink power control recommendation for cross link interference (CLI) reduction in full duplex networks in accordance with one or more aspects of the present disclosure.

FIG. 2 illustrates an example of a resource diagram that supports downlink power control recommendation for CLI reduction in full duplex networks in accordance with one or more aspects of the present disclosure.

FIG. 3 illustrates an example of a wireless communications systems that supports downlink power control recommendation for CLI reduction in full duplex networks in accordance with one or more aspects of the present disclosure.

FIG. 4 illustrates an example of an example of a slot format that supports downlink power control recommendation for CLI reduction in full duplex networks in accordance with one or more aspects of the present disclosure.

FIG. 5 illustrates another example of a wireless communications system that supports downlink power control recommendation for CLI reduction in full duplex networks in accordance with one or more aspects of the present disclosure.

FIG. 6 illustrates an example of a process flow that supports downlink power control recommendation for CLI reduction in full duplex networks in accordance with one or more aspects of the present disclosure.

FIGS. 7 and 8 show block diagrams of devices that support downlink power control recommendation for CLI reduction in full duplex networks in accordance with one or more aspects of the present disclosure.

FIG. 9 shows a block diagram of a communications manager that supports downlink power control recommendation for CLI reduction in full duplex networks in accordance with one or more aspects of the present disclosure.

FIG. 10 shows a diagram of a system including a device that supports downlink power control recommendation for CLI reduction in full duplex networks in accordance with one or more aspects of the present disclosure.

FIGS. 11 and 12 show block diagrams of devices that support downlink power control recommendation for CLI reduction in full duplex networks in accordance with one or more aspects of the present disclosure.

FIG. 13 shows a block diagram of a communications manager that supports downlink power control recommendation for CLI reduction in full duplex networks in accordance with one or more aspects of the present disclosure.

FIG. 14 shows a diagram of a system including a device that supports downlink power control recommendation for CLI reduction in full duplex networks in accordance with one or more aspects of the present disclosure.

FIGS. 15 and 16 show flowcharts illustrating methods that support downlink power control recommendation for CLI reduction in full duplex networks in accordance with one or more aspects of the present disclosure.

### DETAILED DESCRIPTION

Some wireless communications systems may support full-duplex communications, in which downlink and uplink messages are communicated simultaneously. In some cases, full-duplex communications may result in cross link interference (CLI) that is experienced at a user equipment (UE). The CLI may degrade a signal quality of a downlink message received at the UE. In particular, downlink transmissions from a first network entity to a first UE may cause CLI for a second UE (e.g., either interfering with a downlink transmission from a second network entity or a sidelink transmission from a third UE). To reduce CLI caused by the downlink transmission, the power of the downlink transmission may be reduced, but this may also reduce the performance of the downlink transmission (e.g., likelihood of reception by the target UE). The UEs may report channel state information (CSI) or CLI information to the network to indicate channel performance or interference, but such information may not provide a complete picture of decoding performance at the UE to the network. Accordingly, a network entity may be unaware of whether the network entity may reduce downlink transmission power level in order to reduce CLI without affecting downlink accuracy (e.g., decoding performance).

A network entity may transmit control signaling including configuration information for dynamic reporting by the UE of a UE recommended downlink transmission power for the network entity to apply. In accordance with the configuration information, a UE receiving a downlink transmission may monitor performance of the downlink transmission and provide a dynamic downlink transmission power recommendation to the network entity based on the monitored downlink transmission. The configuration information may indicate a dynamic resource via which the UE may transmit a dynamic message (e.g., an uplink control information (UCI) or medium access control (MAC) control element (CE)) including an indication of a recommended downlink transmission power level for the network entity to apply to subsequent downlink transmissions. As the downlink transmission power recommendation is transmitted in a dynamic message, the network entity may dynamically adjust downlink transmission power to manage the tradeoff between CLI at other UEs and the downlink transmission accuracy at the receiving UE. In some examples, the configuration information may indicate for the UE to periodically report a downlink transmission power recommendation, for example in reporting resources linked to CLI reporting resources. In some examples, in accordance with the configuration information, the network entity may dynamically request a downlink transmission power recommendation (e.g., via downlink control information (DCI) or MAC-CE). The UE may determine a recommended downlink transmission power level, for example, based on a relationship between the CSI and a received downlink transmission, a relationship between the CLI and a received downlink transmission, a decoding performance of the UE for a received downlink transmission, a quantity of iterations (e.g., a number of iterations) used to decode a downlink transmission, or a measurement of downlink transmission performance, such as log likelihood ratio (LLR) or block error rate (BLER).

Aspects of the disclosure are initially described in the context of wireless communications systems. Aspects of the disclosure are further illustrated by and described with reference to apparatus diagrams, system diagrams, and flowcharts that relate to downlink power control recommendation for CLI reduction in full duplex networks.

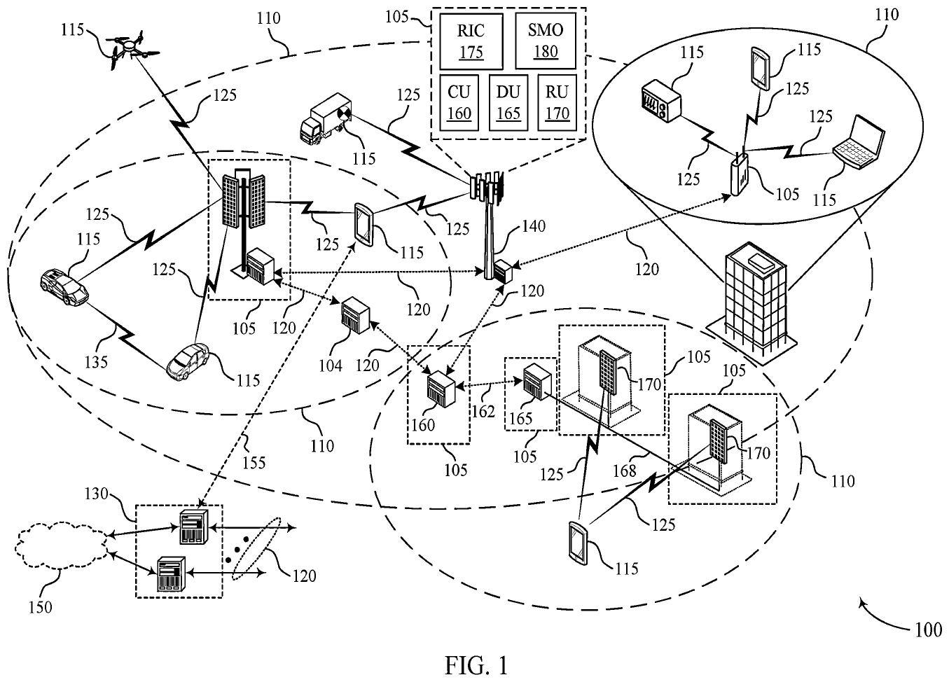

FIG. 1 illustrates an example of a wireless communications system 100 that supports downlink power control recommendation for CLI reduction in full duplex networks in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, anode of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, MAC layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support downlink power control recommendation for CLI reduction in full duplex networks as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, the wireless communications system 100 may support full-duplex communications, in which downlink and uplink messages are communicated simultaneously. In some cases, full-duplex communications may result in CLI that is experienced at a UE 115, which may degrade a signal quality of a downlink message or a sidelink message received at the UE 115. In particular, downlink transmissions from a first network entity 105 to a first UE 115 may cause CLI for a second UE 115 (e.g., either interfering with a downlink transmission from another network entity 105 or a sidelink transmission from a third UE 115). Reducing the power of a downlink transmissions decreases the CLI caused by the downlink transmission to other UEs 115, but may also reduce the performance of the downlink transmission (e.g., likelihood of reception by the target UE 115). The UEs 115 may be configured to report CSI and CLI information to the network, but such information may not give a complete picture of the decoding performance at the UE 115 to the network. For example, while CSI feedback and CLI may provide an indication about the channel quality and interference, CSI feedback and CLI do not provide a complete picture about the decoding performance at the UE 115. For example, at low interference, the UE 115 may be scheduled with a high modulation and coding scheme (MCS) and still decode within a small number of iterations. In the case of retransmission, for example, the UE 115 may know the correctly decoded codebooks, while the network entity may inaccurately think that an entire transport block was received in error. Accordingly, a network entity 105 may not be aware of whether the network entity 105 may reduce downlink transmission power level in order to reduce CLI without affecting downlink accuracy.

A network entity 105 may transmit control signaling including configuration information for dynamic reporting by the UE of a UE recommended downlink transmission power for the network entity to apply. In accordance with the configuration information, a UE 115 receiving a downlink transmission may monitor performance of the downlink transmission. Based on the monitored downlink transmission, the UE 115 may transmit a dynamic message including an indication of a recommended downlink transmission power to the network entity 105. As the downlink transmission power recommendation is transmitted in a dynamic message (e.g., UCI or MAC-CE), the network entity 105 may dynamically adjust downlink transmission power to manage the tradeoff between CLI at other UEs 115 and the downlink transmission accuracy at the receiving UE 115. In some examples, the configuration information may indicate for the UE 115 to periodically report a downlink transmission power recommendation, for example in reporting resources linked to CLI reporting resources. In some examples, in accordance with the configuration information, the network entity 105 may dynamically request a downlink transmission power recommendation (e.g., via DCI or MAC-CE). In some examples, the configuration information may indicate format of the downlink transmission power recommendation (e.g., as an offset relative to a reference power level or an absolute power level from a set of configured (e.g., RRC configured) power levels). The UE 115 may determine a recommended downlink transmission power level, for example based on a relationship between the CSI and a received downlink transmission, a relationship between the CLI and a received downlink transmission, a decoding performance of the UE 115 for a received downlink transmission, a quantity of iterations (e.g., a number of iterations) used to decode a downlink transmission, or a measurement of downlink transmission performance, such as LLR or BLER.

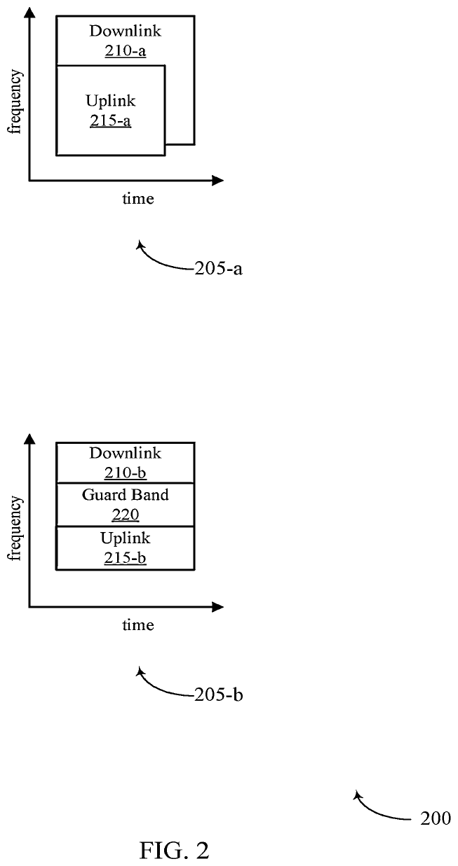

FIG. 2 illustrates an example of a resource diagram 200 that supports multicast scheduling in a full duplex network in accordance with one or more aspects of the present disclosure. The resource diagram 200 may implement aspects of the wireless communications system 100.

As described herein, some wireless communications systems may implement full duplex communications. Full duplex communications may be in-band full duplex (IBFD) communications or subband FDD communications (e.g., flexible duplex).

A first example 205-a illustrates an IBFD example. In IBFD, a wireless device (e.g., a network entity 105 or a UE 115) may transmit and receive at the same time on the same frequency resource. For example, a downlink resources 210-a and uplink resources 215-a may fully or partially overlap (e.g., the downlink resources 210-a and the uplink resources 215-a may share same IBFD time or frequency resources).

A second example 205-b illustrates a subband FDD example. In subband FDD, a wireless device (e.g., a network entity 105 or a UE 115) may transmit and receive at the same time but on different frequency resources. For example, the downlink resources 210-b may be separated from the uplink resources 215-b in the frequency domain (e.g., via a guard band 220).

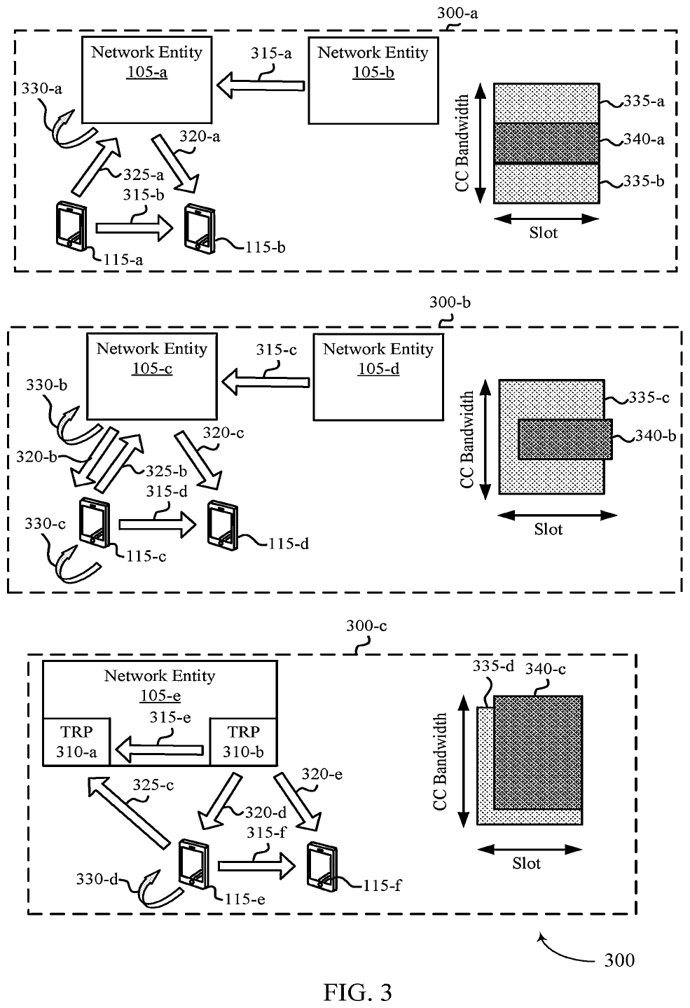

FIG. 3 illustrates an example of a wireless communications system 300-a, a wireless communications system 300-b, and a wireless communications system 300-c that support multicast scheduling in a full duplex network in accordance with one or more aspects of the present disclosure. The wireless communications system 300-a, the wireless communications system 300-b, and the wireless communications system 300-c may implement aspects of the wireless communications system 100. For example, the wireless communications system 300-a may include a first UE 115-a and a second UE 115-b, the wireless communications system 300-b may include a first UE 115-c and a second UE 115-d, and the wireless communications system 300-c may include a first UE 115-e and a second UE 115-f, which may be examples of a UE 115 as described herein. The wireless communications system 300-a may include a network entity 105-a and a network entity 105-b, the wireless communications system 300-b may include a network entity 105-c and a network entity 105-d, and the wireless communications system 300-c may include a network entity 105-e which may be examples of a network entity 105 as described herein.

The wireless communications system 300-a illustrates an example where the network entity 105-a operates in full duplex and each of the first UE 115-a and the second UE 115-b operates in half duplex. For example, the network entity 105-a may transmit downlink signals 320-a to the second UE 115-b using downlink resources (e.g., downlink resources 335-a or downlink resources 335-b), and the first UE 115-a may transmit uplink signals 325-a to the network entity 105-a using uplink resources 340-a. The uplink resources 340-a may be non-overlapping with the downlink resources 335-a and the downlink resources 335-b. The uplink signals 325-a transmitted by the first UE 115-a may cause CLI 315-b at the second UE 115-b. Transmissions by the network entity 105-b may cause CLI 315-a at the network entity 105-a. Transmissions of the downlink signals 320-a by the network entity 105-a may cause self-interference 330-a at the network entity 105-a with respect to reception of the uplink signals 325-a.

The wireless communications system 300-b illustrates an example where the network entity 105-c operates in full duplex and the first UE 115-c operates in full duplex. For example, the network entity 105-c may transmit downlink signals 320-b to the first UE 115-c using downlink resources 335-c, and the first UE 115-c may transmit uplink signals 325-b to the network entity 105-c using uplink resources 340-b. The network entity 105-c may also transmit downlink signals 320-c to the second UE 115-d. The uplink resources 340-b may be overlapping with (e.g., partially or fully overlapping with) the downlink resources 335-c. The uplink signals 325-b transmitted by the first UE 115-c may cause CLI 315-d at the second UE 115-d. Transmissions by the network entity 105-d may cause CLI 315-c at the network entity 105-c. Transmissions of the downlink signals 320-b or the downlink signals 320-c by the network entity 105-c may cause self-interference 330-b at the network entity 105-a with respect to reception of the uplink signals 325-b. Transmissions of the uplink signals 325-b by the first UE 115-c may cause self-interference 330-c at the first UE 115-c with respect to reception of the downlink signals 320-b.

The wireless communications system 300-c illustrates an example where the network entity includes multiple TRPs (e.g., a first TRP 310-a and a second TRP 310-b) and operates in full duplex, and the first UE 115-e operates in full duplex. For example, the first UE 115-e may support subband full duplex (SBFD) operation. For example, the second TRP 310-b may transmit downlink signals 320-d to the first UE 115-e using downlink resources 335-d and the second TRP 310-b may transmit downlink signals 320-e to the second UE 115-f using the downlink resources 335-d. The first UE 115-e may transmit uplink signals 325-c to the first TRP 310-a using uplink resources 340-c. The uplink resources 340-c may be overlapping with (e.g., partially or fully overlapping with) the downlink resources 335-d. Transmissions by the second TRP 310-b of the downlink signals 320-d and the downlink signals 320-e may cause CLI 315-e at the first TRP 310-a. The uplink signals 325-c transmitted by the first UE 115-e may cause CLI 315-f at the second UE 115-f. Transmissions of the uplink signals 325-c by the first UE 115-e may cause self-interference 330-d at the first UE 115-e with respect to reception of the downlink signals 320-d.

Some wireless communications systems may include TDD bands only. Some wireless communications systems (e.g., the wireless communications system 300-a), may include full duplex operation at the network and half duplex operation at the UE. Some wireless communications systems may support SBFD (e.g., no overlapping between downlink and uplink frequency resources).

In some cases, if a UE 115 is operating in a half duplex mode and the network entity 105 is operating in an SBFD/IBFD mode, the UE 115 may experience several sources of interference. For example, a UE 115 may experience inter-cell interference from other network entities 105 (e.g., in the wireless communications system 300-b, the second UE 115-d may experience CLI 315 caused by downlink transmissions by the network entity 105-d). As another example, a UE 115 may experience intra-cell interference from UEs 115 in the same cell (e.g., CLI 315-b, CLI 315-d, or CLI 315-f as shown in the wireless communications system 300-a, the wireless communications system 300-b, and the wireless communications system 300-c, respectively). As another example, a UE 115 may experience inter-cell CLI 315 from UEs 115 in adjacent cells (e.g., in the wireless communications system 300-b, the second UE 115-d may experience CLI 315 caused by UEs 115 in a neighboring cell). Additionally, full duplex UEs 115 may experience self-interference (e.g., self-interference 330-c at the first UE 115-c in the wireless communications system 300-b).

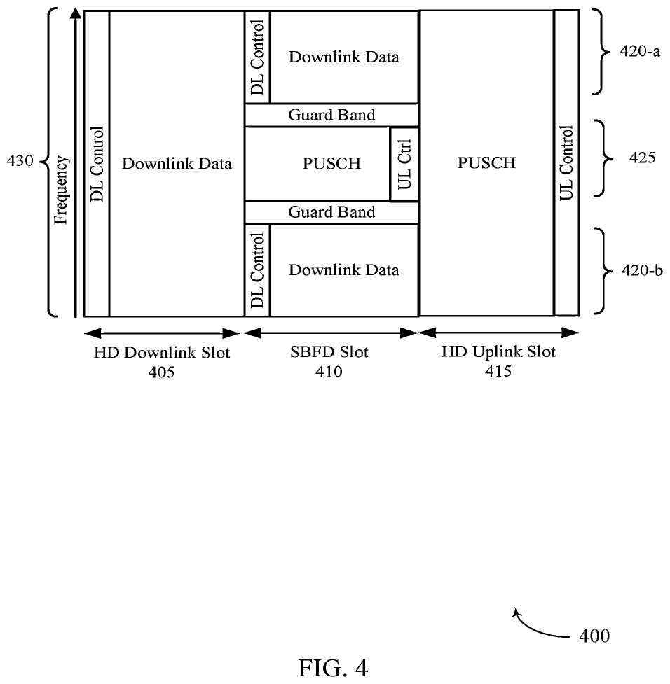

FIG. 4 illustrates an example of a slot format 400 that supports multicast scheduling in a full duplex network in accordance with one or more aspects of the present disclosure. The slot format 400 may implement aspects of the wireless communications system 100, the wireless communications system 300-a, the wireless communications system 300-b, or the wireless communications system 300-c.

The slot format 400 illustrates an example half duplex downlink slot 405, an SBFD slot 410, and a half duplex uplink slot 415 for a carrier bandwidth 430. The half duplex downlink slot 405 includes a downlink control region (e.g., resources for downlink control (e.g., resources for a physical downlink control channel (PDCCH) which may convey a DCI)) and a downlink data region (e.g., resources for physical downlink shared channel (PDSCH)). The half duplex uplink slot 415 includes an uplink data region (e.g., resources for physical uplink shared channel (PUSCH)) and an uplink control region (e.g., resources for uplink control (e.g., resources for a physical uplink control channel (PUCCH) which may convey UCI).

The SBFD slot 410 includes a downlink BWP including a first downlink subband 420-a and a second downlink subband 420-b. In a ‘D+U’ slot, as in SBFD slot 410, the carrier bandwidth 430 may be used for both uplink and downlink transmissions. As illustrated in FIG. 4, the SBFD slot 410 includes an uplink BWP including an uplink subband 425. Guard bands may separate the first downlink subband 420-a and the second downlink subband 420-b from the uplink subband 425. The first downlink subband 420-a includes a downlink control region and a downlink data region. The second downlink subband 420-b includes a downlink control region and a downlink data region. The uplink subband 425 includes a PUSCH region and an uplink control region. In some examples, in a ‘D+U’ slot, downlink and uplink transmissions may occur in overlapping frequency bands (e.g., IBFD operation). In some examples, in a ‘D+U’ slot, as shown in SBFD slot 410, downlink and uplink transmissions may occur in adjacent, non-overlapping bands. If scheduled with a ‘D+U’ slot, a half duplex UE 115 may either transmit in the uplink band (e.g., the uplink subband 425) or receive in the downlink band (e.g., the first downlink subband 420-a and the second downlink subband 420-b). If scheduled with a ‘D+U’ slot, a full duplex UE 115 (e.g., a UE 115 that supports simultaneous transmission and reception) may transmit in the uplink band (e.g., the uplink subband 425) or receive in the downlink band (e.g., the first downlink subband 420-a and the second downlink subband 420-b). A ‘D+U’ slot may include downlink symbols, uplink symbols, or full duplex symbols.

In SBFD, a network entity 105 may configure a downlink transmission to a UE 115 in frequency domain resources adjacent to the frequency domain resources configured for uplink transmission for another UE 115. For example, in the SBFD slot 410, a first UE 115 may transmit an uplink transmission in the uplink subband 425 and a second UE 115 may simultaneously receive a downlink transmission in the first downlink subband 420-a and/or the second downlink subband 420-b. The uplink transmission of the first UE 115 may cause CLI to the downlink reception at the second UE 115. CLI may be caused by energy leakage caused by timing an frequency misalignment between the two UEs 115, or may be caused by automatic gain control (AGC) mismatch if the AGC of the second UE 115 is driven by a downlink serving signal of the second UE 115 but the CLI is strong enough to saturate the AGC of the second UE 115.

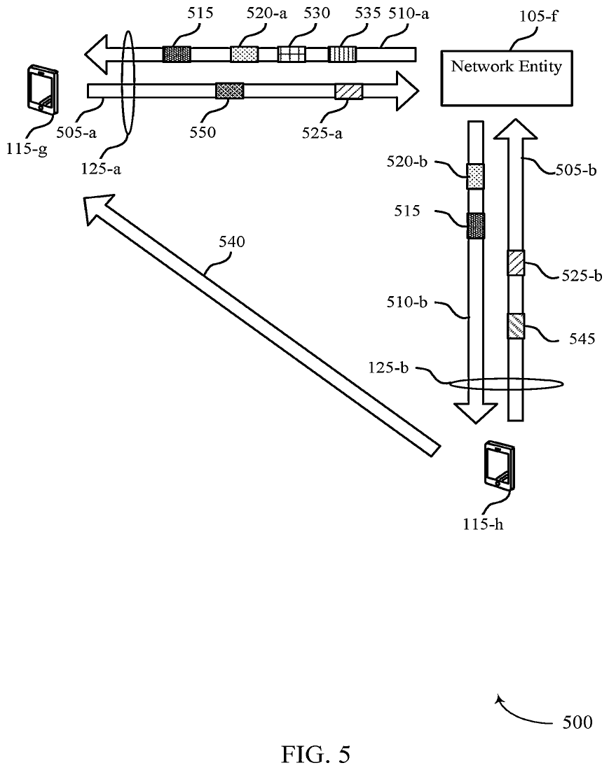

FIG. 5 illustrates an example of a wireless communications system 500 that supports downlink power control recommendation for CLI reduction in full duplex networks in accordance with one or more aspects of the present disclosure. The wireless communications system 500 may implement aspects of the wireless communications system 100. For example, the wireless communications system 500 may include a UE 115-g and a UE 115-h, which may be examples of a UE 115 as described herein. The wireless communications system 500 a may include a network entity 105-f, which may be an example of a network entity 105 as described herein.

The wireless communications system 500 illustrates an example where one or more of the network entity 105-f, the UE 115-g, and the UE 115-h may operate in full duplex. For example, the UE 115-g and/or the UE 115-h may simultaneously communicate with the network entity 105-f over the same frequency band as the network entity 105-f using uplink signals 505-a and 505-b, respectively. The network entity 105-f may simultaneously communicate with the UE 115-g and the UE 115-g over the same frequency band using downlink signals 510-a and 510-b, respectively.

The uplink signals 505 and downlink signals 510 may be communicated over communication links 125. The UE 115-g may communicate with the network entity 105-f using a communication link 125-a, and the UE 115-h may communicate with the network entity 105-f using a communication link 125-b. The communication link 125-a may be an example of an NR or LTE link between the UE 115-g and the network entity 105-f. The communication link 125-b may be an example of an NR or LTE link between the UE 115-h and the network entity 105-f. The communication link 125-a and the communication link 125-b may include bi-directional links that enable both uplink and downlink communications. For example, the UE 115-g may transmit the uplink signals 505-a (e.g., uplink transmissions), such as uplink control signals or uplink data signals, to the network entity 105-f using the communication link 125-a and the network entity 105-f may transmit downlink signals 510-a (e.g., downlink transmissions), such as downlink control signals or downlink data signals, to the UE 115-g using the communication link 125-a. The UE 115-h may transmit uplink signals 505-b (e.g., uplink transmissions), such as uplink control signals or uplink data signals, to the network entity 105-f using the communication link 125-b and the network entity 105-f may transmit downlink signals 510-b (e.g., downlink transmissions), such as downlink control signals or downlink data signals, to the UE 115-h using the communication link 125-b.

In some cases, uplink signals 505-b transmitted by the UE 115-h may cause CLI 540 at the UE 115-g. The wireless communications system 500 may implement a layer 1 CLI framework to provide flexibility to adapt to dynamic CLI. A layer 1 CLI framework, however, may increase layer 1 signaling overhead. A layer 1 CLI measurement may be triggered by a dedicated DCI or a group-common DCI transmitted by the network entity 105-f. An aggressor UE 115 (e.g., the UE 115-h), may be configured with aperiodic, semi-persistent, or periodic non-zero power (NZP) sounding reference signal (SRS) resources. The victim UE 115 (e.g., the UE 115-g) may be configured with aperiodic, semi-persistent, or periodic CLI measurement resources corresponding to the NZP SRS resources. The UE 115-h may transmit SRSs 545 in the configured resources, and the UE 115-g may measure the SRSs using the configured CLI resources. The UE 115-g may transmit a CLI report 550 (e.g., a layer 1 CLI measurement report) to the network entity 105-f. The network entity 105-f may account for the CLI report 550 when scheduling uplink signals 505 and downlink signals 510. The layer 1 reporting framework may support aperiodic, semi-persistent, or periodic CLI reporting based on the timing behavior of the CLI resources. The layer 1 reporting framework may support subband-based CLI measurement and reporting and/or beam-based CLI measurement and reporting (e.g., quasi co-location (QCL) type D for a CLI measurement resource).

In some cases, a CLI report 550 may be based on a CSI reporting framework. A CLI report 550 may be a special type of a CSI report, for example based on an RRC parameter reportQuantity. A CLI report 550 may be an extension of the CSI framework. The CLI measurement resource configured for the UE 115-g may be tied to an interference measurement resource (IMR) or may be a new CLI measurement resource (CLI-MR) (e.g., configured by RRC). For example, the CLI measurement resource may be configured as an IMR with a zero-power (ZP) SRS or a CSI interference measurement (IM). For example, the network entity 105-f may configure a dummy channel measurement resource (CMR) (e.g., CLI may be based on IMR with ZP-SRS or CSI-IM).

In some cases, the wireless communications system 500 may implement a dedicated CLI reporting framework, which may involve a simplified reporting configuration. For example, the CLI measurement resource (e.g., a ZP-SRS or CSI-IM) may be tied to CLI-MR. Such an approach may minimize the impact of CSI processes. The CLI report 550 may be anew UCI type.

The wireless communications system 500 may implement an inter-UE CLI identification/mitigation procedure. The network entity 105-f may group UEs (e.g., including the UE 115-g, the UE 115-h, and other UEs) into sets of co-scheduled UEs (e.g., UEs 115 to be co-scheduled with different directions in SBFD slots). Based on CLI reporting from the victim UEs 115 (e.g., such as the UE 115-g), the network entity 105-f may construct an interference graph for determining the dominant aggressor UEs 115 for each victim UE 115. At a first stage CLI mitigation for UEs 115 in each group, the network entity 105-g may implement scheduling based solutions (e.g., determining time/frequency resources or power control parameters) to minimize the impact of CLI and/or may refine the inter-UE interference graph based on the optimized scheduling. At a second stage CLI mitigation, the network entity 105-f may optimize MCSs, rank, and precoding to reduce CLI. The second stage CLI mitigation may involve enhanced CSI feedback based on an interference hypothesis (e.g., projected CLI interference). The second stage CLI mitigation may involve advanced techniques for CLI reduction at aggressor UEs 115 (e.g., precoding options). The second stage CLI mitigation may involve advanced techniques for CLI mitigation at the victim UEs 115 (e.g., combining options).

In some cases, to provide accurate power reduction for downlink transmissions, the UE 115-g may monitor downlink transmission to provide a dynamic downlink transmission power recommendation to the network entity 105-f based on the monitored downlink transmission.

In particular, the UE-115-g may receive, from the network entity 105-f, control signaling 515 that indicates configuration information for dynamic reporting of a recommended downlink transmission power level for the network entity 105-f to apply for subsequent downlink transmission. The UE 115-g may receive a downlink transmission 520-a in accordance with the control signaling 515, from the network entity 105-f to the UE 115-g. The UE 115-g may provide a dynamic downlink transmission power recommendation in a dynamic message 525-a from the UE 115-g to the network entity 105-f based on the monitored downlink transmission 520-a. As the downlink transmission power recommendation is transmitted in the dynamic message 525-a, which may be in the form of a UCI or MAC-CE, the network entity 105-f may dynamically adjust downlink transmission power to manage the tradeoff between CLI at other UEs 115 (e.g., the UE 115-h) and the downlink transmission accuracy at the receiving UE 115-g.

The UE-115-h may receive, from the network entity 105-f, the control signaling 515 that indicates configuration information for dynamic reporting of the recommended downlink transmission power level for the network entity 105-f to apply for subsequent downlink transmission. The UE 115-h may receive downlink transmission 520-b in accordance with the control signaling 515, from the network entity 105-f to the UE 115-h. The UE 115-g may provide the dynamic downlink transmission power recommendation in a dynamic message 525-b from the UE 115-h to the network entity 105-f based on the monitored downlink transmission 520-b. The descriptions discussed herein with respect to either UE 115-g or UE 115-g may apply to either or both UE 115-g and UE 115-g. That is, the descriptions discussed with respect to UE 115-g may apply to UE 115-h, and the descriptions discussed with respect to UE 115-h may apply to UE 115-g.

In some examples, the network entity 105-f may dynamically request a downlink transmission power recommendation via second control signaling 530, such as via a DCI or MAC-CE request. In some examples, the downlink transmission power recommendation is sent based on periodic reporting (e.g., semi-persistent report) or based on a network request, such as the second control signaling 530. In the periodic reporting, the reporting resources may be configured independently, the reporting resources may be linked to CLI measurement resources, or the reporting resources may be linked to CLI periodic reporting resources. Accordingly, for example, the network entity 105-f may configure the UE 115-g to periodically report a downlink transmission power recommendation in the dynamic message 525-a in reporting resources linked to CLI reporting resources.

For the downlink transmission power recommendation sent based on the network request (e.g., requested by the network via second control signaling 530), the network request may be a dynamic indication, such as a PDSCH DCI format message, DCI 1_0 or DCI 0_0, with an invalid indication or a new DCI indication. In some examples, the network request may be based on MAC-CE.

In some examples, the configuration information in the control signaling 515 may indicate a format for the recommended downlink transmission power level in the dynamic message 525-a. For example, the network may indicate a set of configured power offsets via RRC, and the recommended downlink transmission power level in the dynamic message 525-a may be indicated via indicating one of the power offsets of the set of configured power offsets (which is an offset with respect to a given reference power level). For example, the reference power level may be a CSI-RS 535 power level. In some examples, the CSI-RS 535 that is used as a reference may be indicated by the UE 115-g in the dynamic message 525-a (e.g., from a set of multiple CSI-RSs). In some examples, the configuration information may indicate multiple reporting resources that are available for transmission of dynamic messages 525-a for indicating the recommended downlink transmission power level. Each of the multiple reporting resources may be associated with a given CSI-RS by the configuration information. The UE 115-g may transmit the dynamic message 525-a using a resource linked to the CSI-RS 535 that the UE 115-g uses as a reference for the power offset. In some examples, the configuration information (or other control signaling such as RRC) may indicate a fixed CSI-RS 335 to use as a reference power level, and in such examples, the dynamic message 525-a may not explicitly indicate the CSI-RS 335 that is used as a reference power.

In some examples, the UE 115-g may receive, with the configuration information in the control signaling 515 or via other control signaling (e.g., RRC signaling), a set of absolute downlink transmission power levels. In such examples, the dynamic message 525-a with a selected absolute power level of the set of absolute power levels to indicate the recommended downlink transmission power level. By way of example, the network entity 105-f may indicate, via RRC, four different downlink transmission power levels, and the UE 115-g may select one of the downlink transmission power values based on monitoring downlink transmission(s) from the network entity 105-f. The UE 115-g may indicate the selected downlink transmission power level in the dynamic message 525-a. As another example, an RRC configuration may provide a set of downlink transmission power values and a corresponding bit sequence for each value, and the dynamic message 525-a may include one of the bit sequences to indicate the selected downlink transmission power value from the set of downlink transmission power values.

In some examples, the UE 115-g may provide the recommended downlink transmission power in the dynamic message 525-a based on one or more parameters, such as parameters indicative of an RRC-configured relationship among CSI, CLI, decoding performance, quantity of iterations used in decoding a message, average LLR, or a BLER, based on the downlink transmission 520-a. That is, the UE 115-g may generate measurement information based on the downlink transmission 520, where the recommended downlink transmission power level is based at least in part on the measurement information. The measurement information may correspond to the parameters that are indicative of the RRC-configured relationship. The LLR and BLER may be based on the downlink transmission and the measurement information may include decoding performance of the downlink transmission, as previously mentioned. Moreover, determining a change in a CLI measurement at the UE 115-g or in a CSI measurement at the UE 115-g is based on the downlink transmission, where the recommended downlink transmission power level is based at least in part on the change.

In some examples, the network entity 105-f may receive multiple (e.g., different) downlink power recommendations from multiple UEs 115 (e.g., via the dynamic message 525-a from the UE 115-g, via the dynamic message 525-b from the UE 115-h, and/or via dynamic messages from other UEs 115). The network entity 105-f may adapt downlink transmission power based on the recommendations from the multiple UEs 115, the priority difference between the multiple UEs 115, and the respective signal priorities for the different UEs 115. In some examples, the network entity 105-f may adapt the downlink transmission power to maximize the cell throughput.

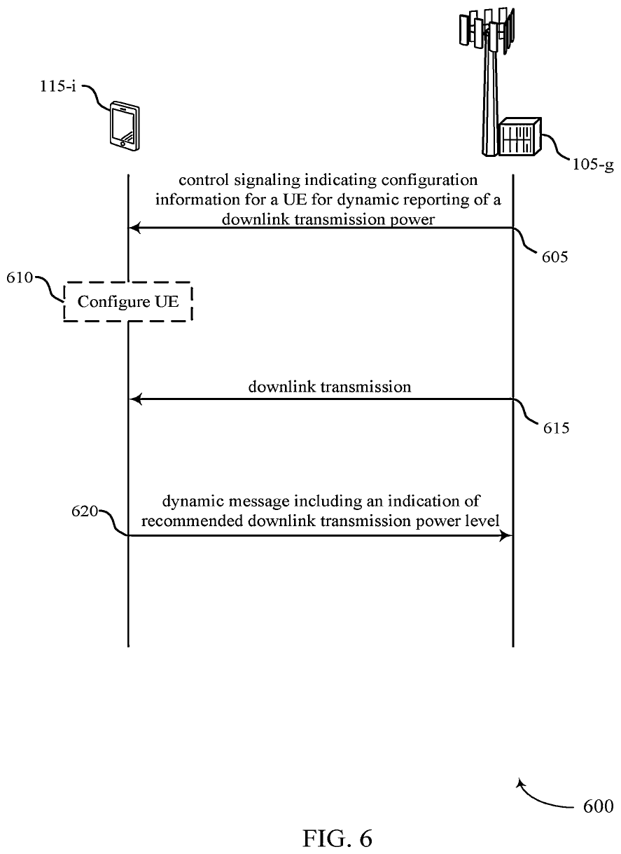

FIG. 6 illustrates an example of a process flow 600 that supports downlink power control recommendation for CLI reduction in full duplex networks in accordance with one or more aspects of the present disclosure. The process flow 600 may include a UE 115-i, which may be an example of a UE 115 as described herein. The process flow 600 may include a network entity 105-g, which may be an example of a network entity 105 as described herein. In the following description of the process flow 600, the operations between the network entity 105-g and the UE 115-i may be transmitted in a different order than the example order shown, or the operations performed by the network entity 105-g and the UE 115-i may be performed in different orders or at different times. Some operations may also be omitted from the process flow 600, and other operations may be added to the process flow 600.

At 605, the UE 115-i may receive, from the network entity 105-g, control signaling including an indication of configuration information for the UE 115-i. The configuration information may facilitate in the UE 115-i dynamic reporting of a UE recommended downlink transmission power for downlink communication from the network entity 105-g to the UE 115-i.

At 610, the UE 115-i may be configured or communicate based at least in part on the configuration information from the control signaling. As such, at 615, the UE 115-i may receive a downlink transmission in accordance with the configuration information. For example, the configuration information may indicate a set of periodic reporting resources for dynamic reporting, where a dynamic message from the UE 115-i is provided to the network entity 105-g via a periodic reporting resource of the set of periodic reporting resources.

In some examples, the network entity 105-g may transmit second control signaling (e.g., a DCI or MAC-CE) requesting that the UE 115-i report the recommended downlink transmission power level in accordance with the configuration information so that the dynamic message may be transmitted in response to the control signaling.

In some examples, the configuration information may include or be received with a set of power offsets and a set of reference powers, where the indication of the recommended downlink transmission power level includes an indication of a selected power offset of the set of power offsets. The indication of the recommended downlink transmission power level may further include an indication of a reference power of the set of reference powers.

In some examples, the configuration information may include or be received with an indication of a set of resources associated with the set of reference powers, where the dynamic message may be transmitted via a resource of the set of resources. In some examples, the set of reference powers may be a CSI-RS signal transmission power. Additionally, in some examples, the configuration information may include or be received with a set of absolute power levels and the dynamic message may include an indication of a selected absolute power level of the set of absolute power levels.

In some examples, the UE 115-i may generate measurement information based on the downlink transmission, where the recommended downlink transmission power level is based at least in part on the measurement information. The measurement information may include generating one of a LLR or a BLER based on the downlink transmission. In some examples, the UE 115-i may generate the measurement information by decoding performance of downlink transmission. In some cases, the UE 115-i may determine a change in a CLI measurement at the UE or in a CSI measurement at the UE 115-i based on the downlink transmission, where the recommended downlink transmission power level is based at least in part on the change.

At 620, the network entity 105-g may receive the dynamic message from the UE 115-i, where the dynamic message includes an indication of the recommended downlink transmission power level based on the downlink transmission (e.g., the measurement and/or reference signal).

In some examples, the network entity 105-g may transmit, to the UE 115-i, a second downlink transmission based on the recommended downlink transmission power level and one or more second recommended downlink transmission powers received from one or more other UEs 115.

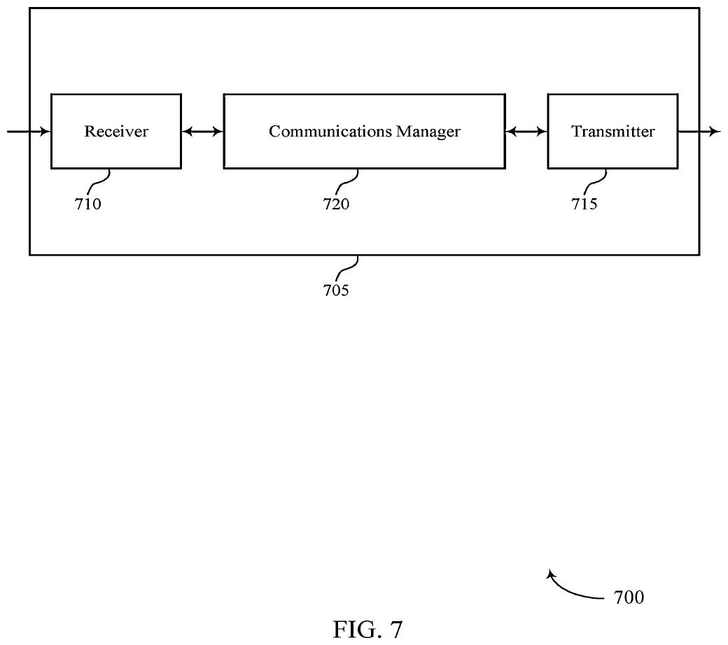

FIG. 7 shows a block diagram 700 of a device 705 that supports downlink power control recommendation for CLI reduction in full duplex networks in accordance with one or more aspects of the present disclosure. The device 705 may be an example of aspects of a UE 115 as described herein. The device 705 may include a receiver 710, a transmitter 715, and a communications manager 720. The device 705 may also include one or more processors, memory coupled with the one or more processors, and instructions stored in the memory that are executable by the one or more processors to enable the one or more processors to perform the downlink power control recommendation for CLI reduction in full duplex networks discussed herein. Each of these components may be in communication with one another (e.g., via one or more buses).

The receiver 710 may provide a means for receiving information such as packets, user data, control information, or any combination thereof associated with various information channels (e.g., control channels, data channels, information channels related to downlink power control recommendation for CLI reduction in full duplex networks). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to downlink power control recommendation for CLI reduction in full duplex networks). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of downlink power control recommendation for CLI reduction in full duplex networks as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. For example, the communications manager 720 may be configured as or otherwise support a means for receiving, from a network entity, control signaling indicating configuration information for dynamic reporting of a recommended downlink transmission power level for the network entity to apply for subsequent downlink transmission. The communications manager 720 may be configured as or otherwise support a means for receiving, from the network entity, a downlink transmission in accordance with the configuration information. The communications manager 720 may be configured as or otherwise support a means for transmitting, to the network entity, a dynamic message including an indication of the recommended downlink transmission power level for the network entity to apply for subsequent downlink transmission based on receiving the downlink transmission in accordance with the configuration information.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for reducing CLI within a wireless communications system 100 while providing accurate downlink transmission, such that the downlink transmissions are occurring as expected within a threshold. For example, the techniques facilitate a network entity 105 to dynamically adjust downlink transmission power to manage the tradeoff between CLI at other UEs 115 and the downlink transmission accuracy at a receiving UE.

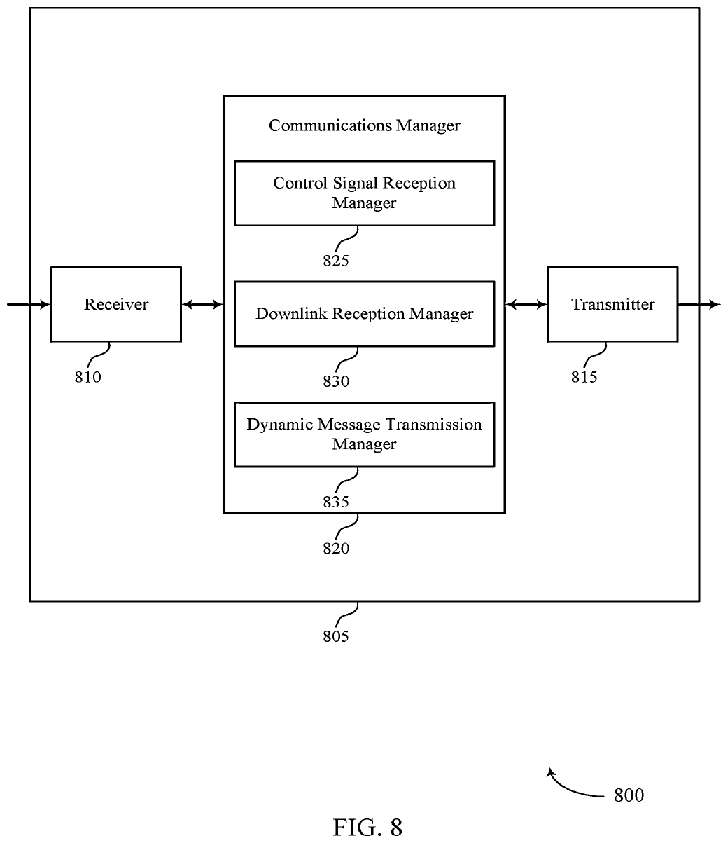

FIG. 8 shows a block diagram 800 of a device 805 that supports downlink power control recommendation for CLI reduction in full duplex networks in accordance with one or more aspects of the present disclosure. The device 805 may be an example of aspects of a device 705 or a UE 115 as described herein. The device 805 may include a receiver 810, a transmitter 815, and a communications manager 820. The device 805 may also include one or more processors, memory coupled with the one or more processors, and instructions stored in the memory that are executable by the one or more processors to enable the one or more processors to perform the downlink power control recommendation for CLI reduction in full duplex networks discussed herein. Each of these components may be in communication with one another (e.g., via one or more buses).

The receiver 810 may provide a means for receiving information such as packets, user data, control information, or any combination thereof associated with various information channels (e.g., control channels, data channels, information channels related to downlink power control recommendation for CLI reduction in full duplex networks). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to downlink power control recommendation for CLI reduction in full duplex networks). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of downlink power control recommendation for CLI reduction in full duplex networks as described herein. For example, the communications manager 820 may include a control signal reception manager 825, a downlink reception manager 830, a dynamic message transmission manager 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a UE in accordance with examples as disclosed herein. The control signal reception manager 825 may be configured as or otherwise support a means for receiving, from a network entity, control signaling indicating configuration information for dynamic reporting of a recommended downlink transmission power level for the network entity to apply for subsequent downlink transmission. The downlink reception manager 830 may be configured as or otherwise support a means for receiving, from the network entity, a downlink transmission in accordance with the configuration information. The dynamic message transmission manager 835 may be configured as or otherwise support a means for transmitting, to the network entity, a dynamic message including an indication of the recommended downlink transmission power level for the network entity to apply for subsequent downlink transmission based on receiving the downlink transmission in accordance with the configuration information.

In some cases, the control signal reception manager 825, the downlink reception manager 830, and the dynamic message transmission manager 835 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the control signal reception manager 825, the downlink reception manager 830, and the dynamic message transmission manager 835 discussed herein. A transceiver processor may be collocated with or communicate with (e.g., direct the operations of) a transceiver of the device. A radio processor may be collocated with or communicate with (e.g., direct the operations of) a radio (e.g., an NR radio, an LTE radio, a Wi-Fi radio) of the device. A transmitter processor may be collocated with or communicate with (e.g., direct the operations of) a transmitter of the device. A receiver processor may be collocated with or communicate with (e.g., direct the operations of) a receiver of the device.

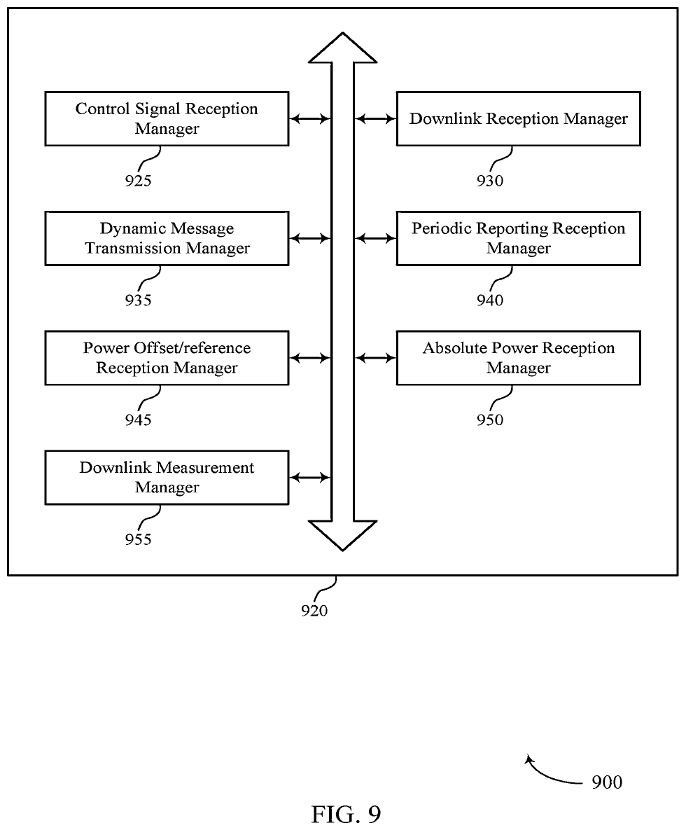

FIG. 9 shows a block diagram 900 of a communications manager 920 that supports downlink power control recommendation for CLI reduction in full duplex networks in accordance with one or more aspects of the present disclosure. The communications manager 920 may be an example of aspects of a communications manager 720, a communications manager 820, or both, as described herein. The communications manager 920, or various components thereof, may be an example of means for performing various aspects of downlink power control recommendation for CLI reduction in full duplex networks as described herein. For example, the communications manager 920 may include a control signal reception manager 925, a downlink reception manager 930, a dynamic message transmission manager 935, a periodic reporting reception manager 940, a power offset/reference reception manager 945, an absolute power reception manager 950, a downlink measurement manager 955, or any combination thereof. Each of these components may communicate, directly or indirectly, with one another (e.g., via one or more buses).

The communications manager 920 may support wireless communications at a UE in accordance with examples as disclosed herein. The control signal reception manager 925 may be configured as or otherwise support a means for receiving, from a network entity, control signaling indicating configuration information for dynamic reporting of a recommended downlink transmission power level for the network entity to apply for subsequent downlink transmission. The downlink reception manager 930 may be configured as or otherwise support a means for receiving, from the network entity, a downlink transmission in accordance with the configuration information. The dynamic message transmission manager 935 may be configured as or otherwise support a means for transmitting, to the network entity, a dynamic message including an indication of the recommended downlink transmission power level for the network entity to apply for subsequent downlink transmission based on receiving the downlink transmission in accordance with the configuration information.

In some examples, to support receiving the control signaling, the periodic reporting reception manager 940 may be configured as or otherwise support a means for receiving, with the configuration information, an indication of a set of periodic reporting resources for the dynamic reporting, and where transmitting the dynamic message includes transmitting the dynamic message via a periodic reporting resource of the set of periodic reporting resources.

In some examples, the control signal reception manager 925 may be configured as or otherwise support a means for receiving, from the network entity, second control signaling requesting that the UE report the recommended downlink transmission power level in accordance with the configuration information, where transmitting the dynamic message is responsive to the second control signaling.

In some examples, to support receiving the control signaling, the power offset/reference reception manager 945 may be configured as or otherwise support a means for receiving, with the configuration information, a set of power offsets and a set of reference powers, and where the indication of the recommended downlink transmission power level includes an indication of a selected power offset of the set of power offsets.

In some examples, the indication of the recommended downlink transmission power level further includes an indication of a reference power of the set of reference powers.

In some examples, to support receiving the control signaling, the power offset/reference reception manager 945 may be configured as or otherwise support a means for receiving, with the configuration information, an indication of a set of resources associated with the set of reference powers, and where transmitting the dynamic message includes transmitting the dynamic message via a resource of the set of resources.

In some examples, the set of reference powers is a CSI-RS transmission power.

In some examples, to support receiving the control signaling, the absolute power reception manager 950 may be configured as or otherwise support a means for receiving, with the configuration information, a set of absolute power levels, where transmitting the dynamic message includes transmitting an indication of a selected absolute power level of the set of absolute power levels.

In some examples, the downlink measurement manager 955 may be configured as or otherwise support a means for generating measurement information based on the downlink transmission, where the recommended downlink transmission power level is based on the measurement information.

In some examples, to support generating the measurement information, the downlink measurement manager 955 may be configured as or otherwise support a means for generating one of a LLR or a BLER based on the downlink transmission.

In some examples, to support generating the measurement information, the downlink measurement manager 955 may be configured as or otherwise support a means for measuring a decoding performance of downlink transmission.

In some examples, the downlink measurement manager 955 may be configured as or otherwise support a means for determining a change in a CLI measurement at the UE or in a CSI measurement at the UE based on the downlink transmission, where the recommended downlink transmission power level is based on the change.

In some cases, the control signal reception manager 925, the downlink reception manager 930, the dynamic message transmission manager 935, the periodic reporting reception manager 940, the power offset/reference reception manager 945, the absolute power reception manager 950, and the downlink measurement manager 955, may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the control signal reception manager 925, the downlink reception manager 930, the dynamic message transmission manager 935, the periodic reporting reception manager 940, the power offset/reference reception manager 945, the absolute power reception manager 950, and the downlink measurement manager 955 discussed herein.

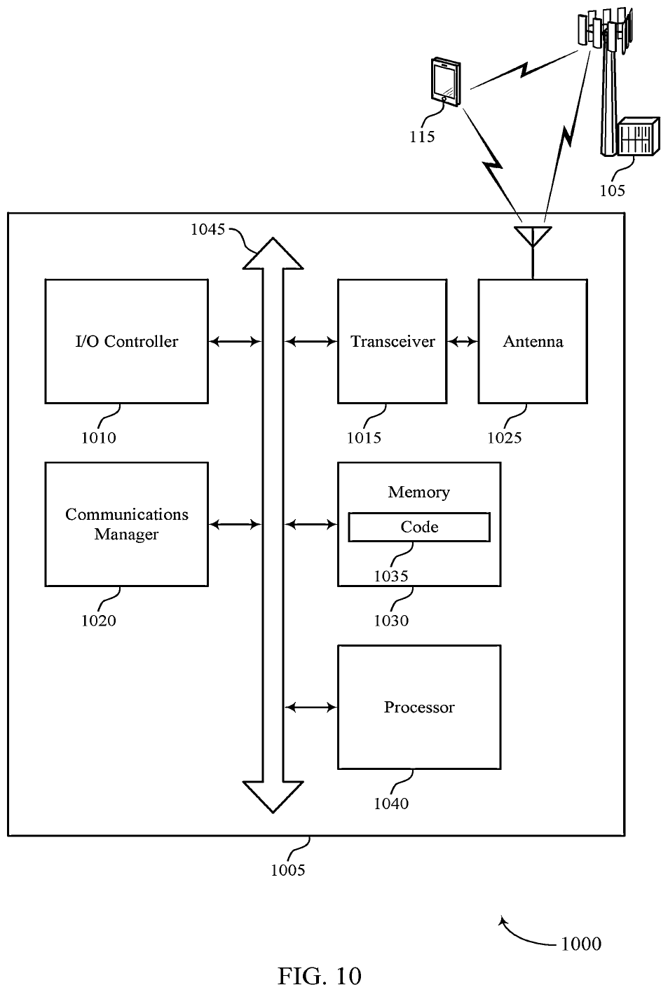

FIG. 10 shows a diagram of a system 1000 including a device 1005 that supports downlink power control recommendation for CLI reduction in full duplex networks in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting downlink power control recommendation for CLI reduction in full duplex networks). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communications at a UE in accordance with examples as disclosed herein. For example, the communications manager 1020 may be configured as or otherwise support a means for receiving, from a network entity, control signaling indicating configuration information for dynamic reporting of a recommended downlink transmission power level for the network entity to apply for subsequent downlink transmission. The communications manager 1020 may be configured as or otherwise support a means for receiving, from the network entity, a downlink transmission in accordance with the configuration information. The communications manager 1020 may be configured as or otherwise support a means for transmitting, to the network entity, a dynamic message including an indication of the recommended downlink transmission power level for the network entity to apply for subsequent downlink transmission based on receiving the downlink transmission in accordance with the configuration information.

By including or configuring the communications manager 1020 in accordance with examples as described herein, the device 1005 may support techniques for reducing CLI within a wireless communication systems 100 while providing accurate downlink transmission, such that the downlink transmissions are occurring as expected within a threshold. For example, the techniques facilitate a network entity 105 to dynamically adjust downlink transmission power to manage the tradeoff between CLI at other UEs 115 and the downlink transmission accuracy at a receiving UE 115.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of downlink power control recommendation for CLI reduction in full duplex networks as described herein, or the processor 1040 and the memory 1030 may be otherwise configured to perform or support such operations.

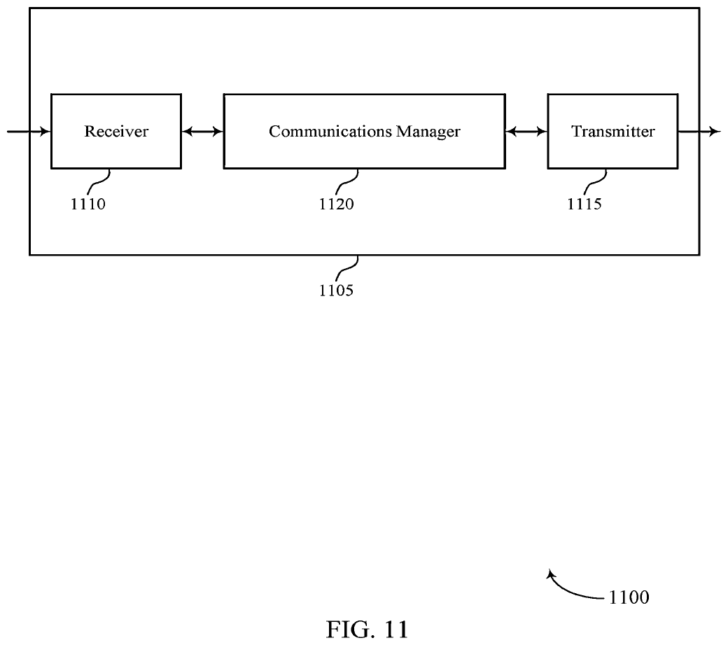

FIG. 11 shows a block diagram 1100 of a device 1105 that supports downlink power control recommendation for CLI reduction in full duplex networks in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include one or more processors, memory coupled with the one or more processors, and instructions stored in the memory that are executable by the one or more processors to enable the one or more processors to perform the downlink power control recommendation for CLI reduction in full duplex networks discussed herein. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of downlink power control recommendation for CLI reduction in full duplex networks as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. For example, the communications manager 1120 may be configured as or otherwise support a means for transmitting, to a UE, control signaling indicating configuration information for dynamic reporting of a recommended downlink transmission power level for the network entity to apply for subsequent downlink transmission. The communications manager 1120 may be configured as or otherwise support a means for transmitting, to the UE, a downlink transmission in accordance with the configuration information. The communications manager 1120 may be configured as or otherwise support a means for receiving, from the UE, a dynamic message including an indication of the recommended downlink transmission power level for the network entity to apply for subsequent downlink transmission based on transmitting the downlink transmission in accordance with the configuration information.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for reducing CLI within a wireless communications system 100 while providing accurate downlink transmission, such that the downlink transmissions are occurring as expected within a threshold. For example, the techniques facilitate a network entity 105 to dynamically adjust downlink transmission power to manage the tradeoff between CLI at other UEs 115 and the downlink transmission accuracy at a receiving UE 115.

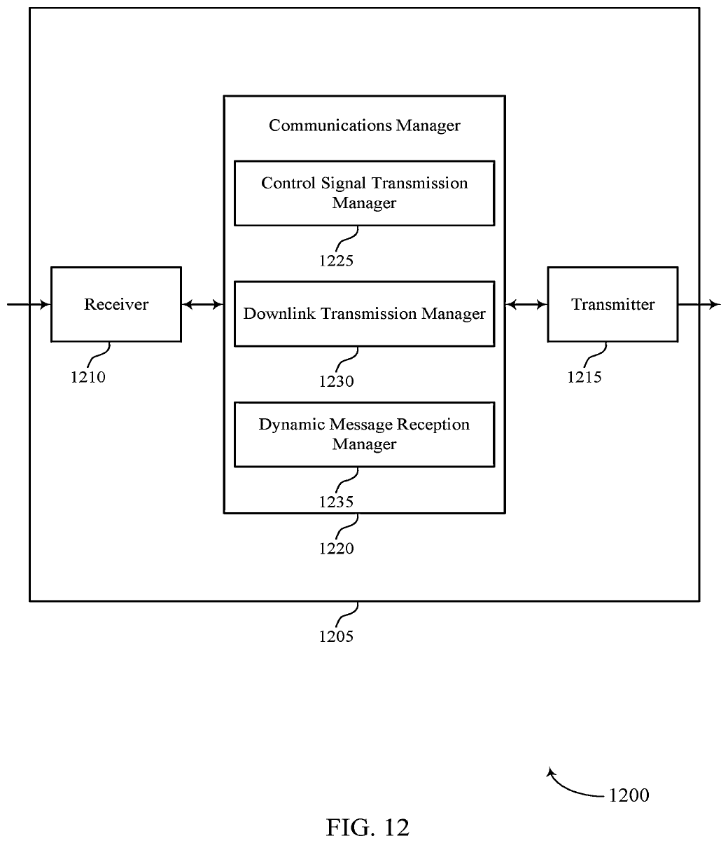

FIG. 12 shows a block diagram 1200 of a device 1205 that supports downlink power control recommendation for CLI reduction in full duplex networks in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include also include one or more processors, memory coupled with the one or more processors, and instructions stored in the memory that are executable by the one or more processors to enable the one or more processors to perform the downlink power control recommendation for CLI reduction in full duplex networks discussed herein. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of downlink power control recommendation for CLI reduction in full duplex networks as described herein. For example, the communications manager 1220 may include a control signal transmission manager 1225, a downlink transmission manager 1230, a dynamic message reception manager 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a network entity in accordance with examples as disclosed herein. The control signal transmission manager 1225 may be configured as or otherwise support a means for transmitting, to a UE, control signaling indicating configuration information for dynamic reporting of a recommended downlink transmission power level for the network entity to apply for subsequent downlink transmission. The downlink transmission manager 1230 may be configured as or otherwise support a means for transmitting, to the UE, a downlink transmission in accordance with the configuration information. The dynamic message reception manager 1235 may be configured as or otherwise support a means for receiving, from the UE, a dynamic message including an indication of the recommended downlink transmission power level for the network entity to apply for subsequent downlink transmission based on transmitting the downlink transmission in accordance with the configuration information.

In some cases, the control signal transmission manager 1225, the downlink transmission manager 1230, and the dynamic message reception manager 1235 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the control signal transmission manager 1225, the downlink transmission manager 1230, and the dynamic message reception manager 1235 discussed herein. A transceiver processor may be collocated with or communicate with (e.g., direct the operations of) a transceiver of the device. A radio processor may be collocated with or communicate with (e.g., direct the operations of) a radio (e.g., an NR radio, an LTE radio, a Wi-Fi radio) of the device. A transmitter processor may be collocated with or communicate with (e.g., direct the operations of) a transmitter of the device. A receiver processor may be collocated with or communicate with (e.g., direct the operations of) a receiver of the device.

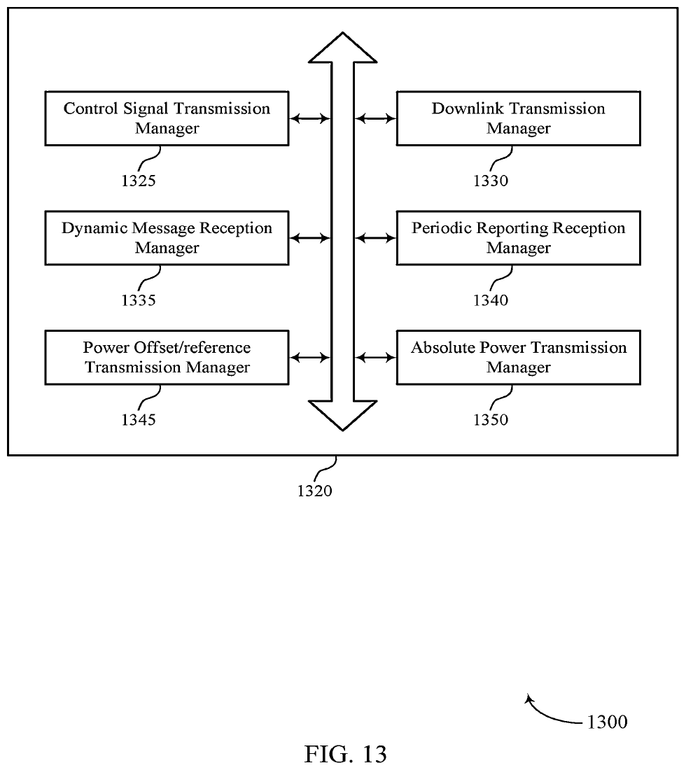

FIG. 13 shows a block diagram 1300 of a communications manager 1320 that supports downlink power control recommendation for CLI reduction in full duplex networks in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of downlink power control recommendation for CLI reduction in full duplex networks as described herein. For example, the communications manager 1320 may include a control signal transmission manager 1325, a downlink transmission manager 1330, a dynamic message reception manager 1335, a periodic reporting reception manager 1340, a power offset/reference transmission manager 1345, an absolute power transmission manager 1350, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications at a network entity in accordance with examples as disclosed herein. The control signal transmission manager 1325 may be configured as or otherwise support a means for transmitting, to a UE, control signaling indicating configuration information for dynamic reporting of a recommended downlink transmission power level for the network entity to apply for subsequent downlink transmission. The downlink transmission manager 1330 may be configured as or otherwise support a means for transmitting, to the UE, a downlink transmission in accordance with the configuration information. The dynamic message reception manager 1335 may be configured as or otherwise support a means for receiving, from the UE, a dynamic message including an indication of the recommended downlink transmission power level for the network entity to apply for subsequent downlink transmission based on transmitting the downlink transmission in accordance with the configuration information.

In some examples, the downlink transmission manager 1330 may be configured as or otherwise support a means for transmitting, to the UE, a second downlink transmission based on the recommended downlink transmission power level and one or more second recommended downlink transmission powers received from one or more other UEs.

In some examples, to support transmitting the control signaling, the periodic reporting reception manager 1340 may be configured as or otherwise support a means for transmitting, with the configuration information, an indication of a set of periodic reporting resources for the dynamic reporting, and where receiving the dynamic message includes receiving the dynamic message via a periodic reporting resource of the set of periodic reporting resources.

In some examples, the control signal transmission manager 1325 may be configured as or otherwise support a means for transmitting, to the UE, second control signaling requesting that the UE report the recommended downlink transmission power level in accordance with the configuration information, where receiving the dynamic message is based on the second control signaling.

In some examples, to support transmitting the control signaling, the power offset/reference transmission manager 1345 may be configured as or otherwise support a means for transmitting, with the configuration information, a set of power offsets and a set of reference powers, and where the indication of the recommended downlink transmission power level includes an indication of a selected power offset of the set of power offsets.

In some examples, the indication of the recommended downlink transmission power level further includes an indication of a reference power of the set of reference powers.

In some examples, to support transmitting the control signaling, the control signal transmission manager 1325 may be configured as or otherwise support a means for transmitting, with the configuration information, an indication of a set of resources associated with the set of reference powers, and where receiving the dynamic message includes receiving the dynamic message via a resource of the set of resources.

In some examples, the set of reference powers is a CSI-RS transmission power.

In some examples, to support transmitting the control signaling, the absolute power transmission manager 1350 may be configured as or otherwise support a means for transmitting, with the configuration information, a set of absolute power levels, where receiving the dynamic message includes receiving an indication of a selected absolute power level of the set of absolute power levels.

In some cases, the control signal transmission manager 1325, the downlink transmission manager 1330, the dynamic message reception manager 1335, the periodic reporting reception manager 1340, the power offset/reference transmission manager 1345, and the absolute power transmission manager 1350, may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the control signal transmission manager 1325, the downlink transmission manager 1330, the dynamic message reception manager 1335, the periodic reporting reception manager 1340, the power offset/reference transmission manager 1345, and the absolute power transmission manager 1350 discussed herein.

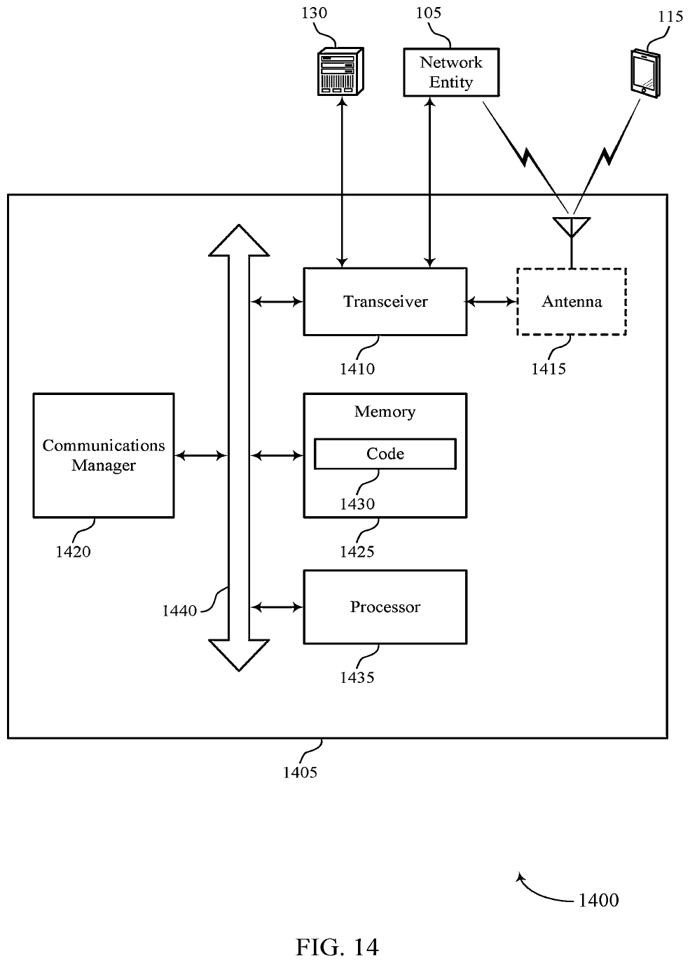

FIG. 14 shows a diagram of a system 1400 including a device 1405 that supports downlink power control recommendation for CLI reduction in full duplex networks in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting downlink power control recommendation for CLI reduction in full duplex networks). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communications at a network entity in accordance with examples as disclosed herein. For example, the communications manager 1420 may be configured as or otherwise support a means for transmitting, to a UE, control signaling indicating configuration information for dynamic reporting of a recommended downlink transmission power level for the network entity to apply for subsequent downlink transmission. The communications manager 1420 may be configured as or otherwise support a means for transmitting, to the UE, a downlink transmission in accordance with the configuration information. The communications manager 1420 may be configured as or otherwise support a means for receiving, from the UE, a dynamic message including an indication of the recommended downlink transmission power level for the network entity to apply for subsequent downlink transmission based on transmitting the downlink transmission in accordance with the configuration information.

By including or configuring the communications manager 1420 in accordance with examples as described herein, the device 1405 may support techniques for more efficient utilization of communication resources, such as by reducing CLI within a wireless communications system 100 while providing accurate downlink transmission (e.g., downlink transmissions are occurring as expected within a threshold). For example, the techniques facilitate a network entity 105 to dynamically adjust downlink transmission power to manage the tradeoff between CLI at other UEs 115 and the downlink transmission accuracy at a receiving UE 115.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of downlink power control recommendation for CLI reduction in full duplex networks as described herein, or the processor 1435 and the memory 1425 may be otherwise configured to perform or support such operations.

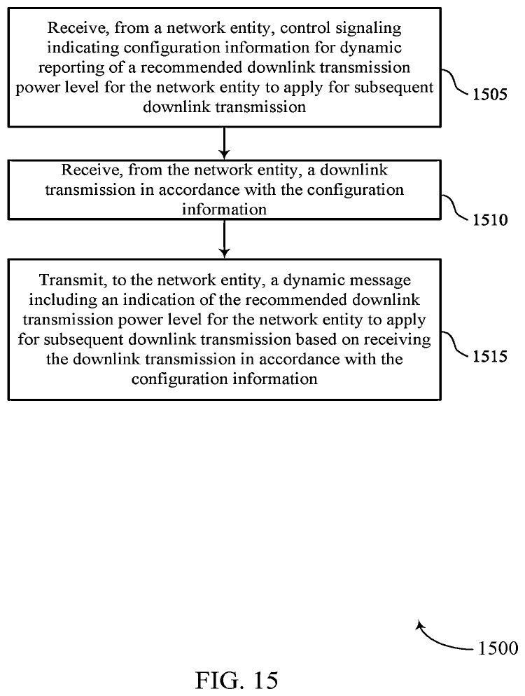

FIG. 15 shows a flowchart illustrating a method 1500 that supports downlink power control recommendation for CLI reduction in full duplex networks in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving, from a network entity, control signaling indicating configuration information for dynamic reporting of a recommended downlink transmission power level for the network entity to apply for subsequent downlink transmission. The operations of 1505 may be performed in accordance with examples as disclosed herein. In some examples, aspects of the operations of 1505 may be performed by a control signal reception manager 925 as described with reference to FIG. 9.

At 1510, the method may include receiving, from the network entity, a downlink transmission in accordance with the configuration information. The operations of 1510 may be performed in accordance with examples as disclosed herein. In some examples, aspects of the operations of 1510 may be performed by a downlink reception manager 930 as described with reference to FIG. 9.

At 1515, the method may include transmitting, to the network entity, a dynamic message including an indication of the recommended downlink transmission power level for the network entity to apply for subsequent downlink transmission based on receiving the downlink transmission in accordance with the configuration information. The operations of 1515 may be performed in accordance with examples as disclosed herein. In some examples, aspects of the operations of 1515 may be performed by a dynamic message transmission manager 935 as described with reference to FIG. 9.

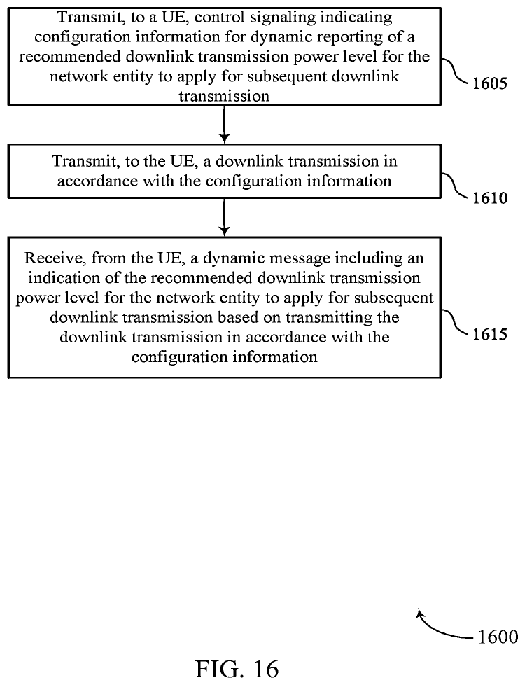

FIG. 16 shows a flowchart illustrating a method 1600 that supports downlink power control recommendation for CLI reduction in full duplex networks in accordance with one or more aspects of the present disclosure. The operations of the method 1600 may be implemented by a network entity or its components as described herein. For example, the operations of the method 1600 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1605, the method may include transmitting, to a UE, control signaling indicating configuration information for dynamic reporting of a recommended downlink transmission power level for the network entity to apply for subsequent downlink transmission. The operations of 1605 may be performed in accordance with examples as disclosed herein. In some examples, aspects of the operations of 1605 may be performed by a control signal transmission manager 1325 as described with reference to FIG. 13.

At 1610, the method may include transmitting, to the UE, a downlink transmission in accordance with the configuration information. The operations of 1610 may be performed in accordance with examples as disclosed herein. In some examples, aspects of the operations of 1610 may be performed by a downlink transmission manager 1330 as described with reference to FIG. 13.

At 1615, the method may include receiving, from the UE, a dynamic message including an indication of the recommended downlink transmission power level for the network entity to apply for subsequent downlink transmission based on transmitting the downlink transmission in accordance with the configuration information. The operations of 1615 may be performed in accordance with examples as disclosed herein. In some examples, aspects of the operations of 1615 may be performed by a dynamic message reception manager 1335 as described with reference to FIG. 13.

The following provides an overview of aspects of the present disclosure:

Aspect 1: A method for wireless communications at a UE, comprising: receiving, from a network entity, control signaling indicating configuration information for dynamic reporting of a recommended downlink transmission power level for the network entity to apply for subsequent downlink transmission; receiving, from the network entity, a downlink transmission in accordance with the configuration information; and transmitting, to the network entity, a dynamic message including an indication of the recommended downlink transmission power level for the network entity to apply for subsequent downlink transmission based on receiving the downlink transmission in accordance with the configuration information.

Aspect 2: The method of aspect 1, wherein receiving the control signaling comprises: receiving, with the configuration information, an indication of a set of periodic reporting resources for the dynamic reporting, and wherein transmitting the dynamic message comprises transmitting the dynamic message via a periodic reporting resource of the set of periodic reporting resources.

Aspect 3: The method of any of aspects 1 through 2, further comprising: receiving, from the network entity, second control signaling requesting that the UE report the recommended downlink transmission power level in accordance with the configuration information, wherein transmitting the dynamic message is responsive to the second control signaling.

Aspect 4: The method of any of aspects 1 through 3, wherein receiving the control signaling comprises: receiving, with the configuration information, a set of power offsets and a set of reference powers, and wherein the indication of the recommended downlink transmission power level comprises an indication of a selected power offset of the set of power offsets.

Aspect 5: The method of aspect 4, wherein the indication of the recommended downlink transmission power level further comprises an indication of a reference power of the set of reference powers.

Aspect 6: The method of aspect 4, wherein receiving the control signaling comprises: receiving, with the configuration information, an indication of a set of resources associated with the set of reference powers, and wherein transmitting the dynamic message comprises transmitting the dynamic message via a resource of the set of resources.

Aspect 7: The method of any of aspects 4 through 6, wherein the set of reference powers is a CSI reference signal transmission power.

Aspect 8: The method of any of aspects 1 through 3, wherein receiving the control signaling comprises: receiving, with the configuration information, a set of absolute power levels, wherein transmitting the dynamic message comprises transmitting an indication of a selected absolute power level of the set of absolute power levels.

Aspect 9: The method of any of aspects 1 through 8, further comprising: generating measurement information based on the downlink transmission, wherein the recommended downlink transmission power level is based at least in part on the measurement information.

Aspect 10: The method of aspect 9, wherein generating the measurement information comprises: generating one of a log likelihood ratio (LLR) or a block error ratio (BLER) based on the downlink transmission.

Aspect 11: The method of any of aspects 9 through 10, wherein generating the measurement information comprises: measuring a decoding performance of downlink transmission.

Aspect 12: The method of any of aspects 1 through 11, further comprising: determining a change in a CLI measurement at the UE or in a CSI measurement at the UE based on the downlink transmission, wherein the recommended downlink transmission power level is based at least in part on the change.

Aspect 13: A method for wireless communications at a network entity, comprising: transmitting, to a UE, control signaling indicating configuration information for dynamic reporting of a recommended downlink transmission power level for the network entity to apply for subsequent downlink transmission; transmitting, to the UE, a downlink transmission in accordance with the configuration information; and receiving, from the UE, a dynamic message including an indication of the recommended downlink transmission power level for the network entity to apply for subsequent downlink transmission based on transmitting the downlink transmission in accordance with the configuration information.

Aspect 14: The method of aspect 13, further comprising: transmitting, to the UE, a second downlink transmission based at least in part on the recommended downlink transmission power level and one or more second recommended downlink transmission powers received from one or more other UEs.

Aspect 15: The method of any of aspects 13 through 14, wherein transmitting the control signaling comprises: transmitting, with the configuration information, an indication of a set of periodic reporting resources for the dynamic reporting, and wherein receiving the dynamic message comprises receiving the dynamic message via a periodic reporting resource of the set of periodic reporting resources.

Aspect 16: The method of any of aspects 13 through 15, further comprising: transmitting, to the UE, second control signaling requesting that the UE report the recommended downlink transmission power level in accordance with the configuration information, wherein receiving the dynamic message is based at least in part on the second control signaling.

Aspect 17: The method of any of aspects 13 through 16, wherein transmitting the control signaling comprises: transmitting, with the configuration information, a set of power offsets and a set of reference powers, and wherein the indication of the recommended downlink transmission power level comprises an indication of a selected power offset of the set of power offsets.

Aspect 18: The method of aspect 17, wherein the indication of the recommended downlink transmission power level further comprises an indication of a reference power of the set of reference powers.

Aspect 19: The method of aspect 17, wherein transmitting the control signaling comprises: transmitting, with the configuration information, an indication of a set of resources associated with the set of reference powers, and wherein receiving the dynamic message comprises receiving the dynamic message via a resource of the set of resources.

Aspect 20: The method of any of aspects 17 through 19, wherein the set of reference powers is a CSI reference signal transmission power.

Aspect 21: The method of any of aspects 13 through 15, wherein transmitting the control signaling comprises: transmitting, with the configuration information, a set of absolute power levels, wherein receiving the dynamic message comprises receiving an indication of a selected absolute power level of the set of absolute power levels.

Aspect 22: An apparatus for wireless communications at a UE, comprising a processor; memory coupled with the processor; and instructions stored in the memory and executable by the processor to cause the apparatus to perform a method of any of aspects 1 through 12.

Aspect 23: An apparatus for wireless communications at a UE, comprising at least one means for performing a method of any of aspects 1 through 12.

Aspect 24: A non-transitory computer-readable medium storing code for wireless communications at a UE, the code comprising instructions executable by a processor to perform a method of any of aspects 1 through 12.

Aspect 25: An apparatus for wireless communications at a network entity, comprising a processor; memory coupled with the processor; and instructions stored in the memory and executable by the processor to cause the apparatus to perform a method of any of aspects 13 through 21.

Aspect 26: An apparatus for wireless communications at a network entity, comprising at least one means for performing a method of any of aspects 13 through 21.

Aspect 27: A non-transitory computer-readable medium storing code for wireless communications at a network entity, the code comprising instructions executable by a processor to perform a method of any of aspects 13 through 21.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory coupled with the processor; and
instructions stored in the memory and executable by the processor to cause the apparatus to:
receive, from a network entity, control signaling indicating configuration information for dynamic reporting of a recommended downlink transmission power level for the network entity to apply for subsequent downlink transmission;
receive, from the network entity, a downlink transmission in accordance with the configuration information; and
transmit, to the network entity, a dynamic message including an indication of the recommended downlink transmission power level for the network entity to apply for subsequent downlink transmission based on reception of the downlink transmission in accordance with the configuration information.

2. The apparatus of claim 1, wherein the instructions are further executable by the processor to receive the control signaling by being executable by the processor to:
receive, with the configuration information, an indication of a set of periodic reporting resources for the dynamic reporting, and wherein transmission of the dynamic message comprises transmission of the dynamic message via a periodic reporting resource of the set of periodic reporting resources.

3. The apparatus of claim 1, wherein the instructions are further executable by the processor to cause the apparatus to:
receive, from the network entity, second control signaling requesting that the UE report the recommended downlink transmission power level in accordance with the configuration information, wherein transmission of the dynamic message is responsive to the second control signaling.

4. The apparatus of claim 1, wherein the instructions are further executable by the processor to receive the control signaling by being executable by the processor to:
receive, with the configuration information, a set of power offsets and a set of reference powers, and wherein the indication of the recommended downlink transmission power level comprises an indication of a selected power offset of the set of power offsets.

5. The apparatus of claim 4, wherein the indication of the recommended downlink transmission power level further comprises an indication of a reference power of the set of reference powers.

6. The apparatus of claim 4, wherein the instructions are further executable by the processor to receive the control signaling by being executable by the processor to:
receive, with the configuration information, an indication of a set of resources associated with the set of reference powers, and wherein transmission of the dynamic message comprises transmission of the dynamic message via a resource of the set of resources.

7. The apparatus of claim 4, wherein the set of reference powers is a channel state information reference signal transmission power.

8. The apparatus of claim 1, wherein the instructions are further executable by the processor to receive the control signaling by being executable by the processor to:
receive, with the configuration information, a set of absolute power levels, wherein transmission of the dynamic message comprises transmission of an indication of a selected absolute power level of the set of absolute power levels.

9. The apparatus of claim 1, wherein the instructions are further executable by the processor to cause the apparatus to:
generate measurement information based on the downlink transmission, wherein the recommended downlink transmission power level is based at least in part on the measurement information.

10. The apparatus of claim 9, wherein the instructions are further executable by the processor to generate the measurement information by being executable by the processor to:
generate one of a log likelihood ratio or a block error rate based on the downlink transmission.

11. The apparatus of claim 9, wherein the instructions are further executable by the processor to generate the measurement information by being executable by the processor to:
measure a decoding performance of downlink transmission.

12. The apparatus of claim 1, wherein the instructions are further executable by the processor to cause the apparatus to:
determine a change in a cross link interference measurement at the UE or in a channel state information measurement at the UE based on the downlink transmission, wherein the recommended downlink transmission power level is based at least in part on the change.

13. An apparatus for wireless communications at a network entity, comprising:
a processor;
memory coupled with the processor; and
instructions stored in the memory and executable by the processor to cause the apparatus to:
transmit, to a user equipment (UE), control signaling indicating configuration information for dynamic reporting of a recommended downlink transmission power level for the network entity to apply for subsequent downlink transmission;
transmit, to the UE, a downlink transmission in accordance with the configuration information; and
receive, from the UE, a dynamic message including an indication of the recommended downlink transmission power level for the network entity to apply for subsequent downlink transmission based on transmission of the downlink transmission in accordance with the configuration information.

14. The apparatus of claim 13, wherein the instructions are further executable by the processor to cause the apparatus to:
transmit, to the UE, a second downlink transmission based at least in part on the recommended downlink transmission power level and one or more second recommended downlink transmission powers received from one or more other UEs.

15. The apparatus of claim 13, wherein the instructions are further executable by the processor to transmit the control signaling by being executable by the processor to:
transmit, with the configuration information, an indication of a set of periodic reporting resources for the dynamic reporting, and wherein reception of the dynamic message comprises reception of the dynamic message via a periodic reporting resource of the set of periodic reporting resources.

16. The apparatus of claim 13, wherein the instructions are further executable by the processor to cause the apparatus to:
transmit, to the UE, second control signaling requesting that the UE report the recommended downlink transmission power level in accordance with the configuration information, wherein reception of the dynamic message is based at least in part on the second control signaling.

17. The apparatus of claim 13, wherein the instructions are further executable by the processor to transmit the control signaling by being executable by the processor to:
transmit, with the configuration information, a set of power offsets and a set of reference powers, and wherein the indication of the recommended downlink transmission power level comprises an indication of a selected power offset of the set of power offsets.

18. The apparatus of claim 17, wherein the indication of the recommended downlink transmission power level further comprises an indication of a reference power of the set of reference powers.

19. The apparatus of claim 17, wherein the instructions are further executable by the processor to receive the control signaling by being executable by the processor to:
transmit, with the configuration information, an indication of a set of resources associated with the set of reference powers, and wherein reception of the dynamic message comprises reception of the dynamic message via a resource of the set of resources.

20. The apparatus of claim 17, wherein the set of reference powers is a channel state information reference signal transmission power.

21. The apparatus of claim 13, wherein the instructions are further executable by the processor to receive the control signaling by being executable by the processor to:
transmit, with the configuration information, a set of absolute power levels, wherein reception of the dynamic message comprises reception of an indication of a selected absolute power level of the set of absolute power levels.

22. A method for wireless communications at a user equipment (UE), comprising:
receiving, from a network entity, control signaling indicating configuration information for dynamic reporting of a recommended downlink transmission power level for the network entity to apply for subsequent downlink transmission;
receiving, from the network entity, a downlink transmission in accordance with the configuration information; and
transmitting, to the network entity, a dynamic message including an indication of the recommended downlink transmission power level for the network entity to apply for subsequent downlink transmission based on receiving the downlink transmission in accordance with the configuration information.

23. The method of claim 22, wherein receiving the control signaling comprises:
receiving, with the configuration information, an indication of a set of periodic reporting resources for the dynamic reporting, and wherein transmitting the dynamic message comprises transmitting the dynamic message via a periodic reporting resource of the set of periodic reporting resources.

24. The method of claim 22, further comprising:
receiving, from the network entity, second control signaling requesting that the UE report the recommended downlink transmission power level in accordance with the configuration information, wherein transmitting the dynamic message is responsive to the second control signaling.

25. The method of claim 22, wherein receiving the control signaling comprises:
receiving, with the configuration information, a set of power offsets and a set of reference powers, and wherein the indication of the recommended downlink transmission power level comprises an indication of a selected power offset of the set of power offsets.

26. The method of claim 25, wherein the indication of the recommended downlink transmission power level further comprises an indication of a reference power of the set of reference powers.

27. The method of claim 25, wherein receiving the control signaling comprises:
receiving, with the configuration information, an indication of a set of resources associated with the set of reference powers, and wherein transmitting the dynamic message comprises transmitting the dynamic message via a resource of the set of resources.

28. The method of claim 25, wherein the set of reference powers is a channel state information reference signal transmission power.

29. The method of claim 22, wherein receiving the control signaling comprises:
receiving, with the configuration information, a set of absolute power levels, wherein transmitting the dynamic message comprises transmitting an indication of a selected absolute power level of the set of absolute power levels.

30. A method for wireless communications at a network entity, comprising:
transmitting, to a user equipment (UE), control signaling indicating configuration information for dynamic reporting of a recommended downlink transmission power level for the network entity to apply for subsequent downlink transmission;
transmitting, to the UE, a downlink transmission in accordance with the configuration information; and
receiving, from the UE, a dynamic message including an indication of the recommended downlink transmission power level for the network entity to apply for subsequent downlink transmission based on transmitting the downlink transmission in accordance with the configuration information.
